(19) United States
(12) Patent Application Publication
(10) Pub. No.: US 2005/0216826 A1
(43) Pub. Date: Sep. 29, 2005

(54) Method of providing a concurrent overview and detailed display of industrial production facilities

(75) Inventors: N. Timothy Black, Edmonton (CA); Warren R. Mitchell, St. Albert (CA); David Shook, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Matrikon Inc., Edmonton (CA)

(21) Appl. No.: 11/124,660

(22) Filed: May 9, 2005

(51) Int. Cl. G06F 7/00

(52) U.S. Cl. 715/502

(57) ABSTRACT

A method of providing a concurrent overview and detailed display of an industrial production facility, involving the step of monitoring selected assets of an industrial production facility by assigning to each of the selected assets a space on a visual display. A selected attribute common to some or all of the selected assets is reflected in a size of the space assigned to an individual one of the selected assets, such that selected assets having more of the selected attribute are assigned a proportionately larger space than selected assets having less of the selected attribute.

### FIELD OF THE INVENTION

The present invention relates to a method of displaying information in a meaningful way to enable personnel to more effectively monitor the operation of industrial production facilities.

### BACKGROUND OF THE INVENTION

In industrial settings, managing the performance and condition of assets within a production facility is made difficult by the overall large number of these assets, the large number of asset types, and the large number of attributes that describe the condition and performance of the assets and the relationships between the assets. For example, a small chemical plant will have dozens of tanks, dozens of reaction vessels, dozens of controllers, hundreds of valves, hundreds of sensors, hundreds of pumps and miles of piping.

One commonly used prior-art system for comparing multiple attributes of multiple items populates a table with the information and allows the person viewing it to control which rows and columns of the table are visible. This implementation is often called an “electronic spreadsheet”. To make comparisons, the person viewing the table reads numerical and textual information in the various cells of the table. Another prior art system is the “digital dashboard”, which displays high-level summaries without displaying the constituent data. Sometimes the display is integrated with process controls to enable an operator to adjust the process controls in response to data displayed, as is taught in U.S. Pat. No. 4,001,807 (Dallimonti 1977).

### SUMMARY OF THE INVENTION

According to the present invention there is provided a method of providing a concurrent overview and detailed display of an industrial production facility. The method involves the step of monitoring selected assets of an industrial production facility by assigning to each of the selected assets a space on a visual display. A selected attribute common to some or all of the selected assets being reflected in a size of the space assigned to an individual one of the selected assets, such that selected assets having more of the selected attribute are assigned a proportionately larger space than selected assets having less of the selected attribute.

As will be hereafter described with reference to an example, such a display permits supervisory personnel to more readily monitor industrial production facilities. There will also be described means by which additional attributes may be concurrently monitored.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a front elevation view of a concurrent overview and detailed display of industrial production facilities in accordance with the teachings of the present invention, based upon a selected attribute of operating efficiency.

FIG. 2 is a detailed front elevation view of the display illustrated in FIG. 1, with a supplemental information pane being activated.

FIG. 3 is a front elevation view of the display illustrated in FIG. 1, based upon a selected attribute of total production.

FIG. 4 is a perspective view of computer equipment necessary for the display illustrated in FIG. 1.

FIG. 5 is a block diagram showing system components necessary for the display illustrated in FIG. 1.

FIG. 6 is a front elevation view of the display illustrated in FIG. 1, with a graphical overlay being activated.

### DETAILED DESCRIPTION OF THE PREFERRED EMBODIMENT

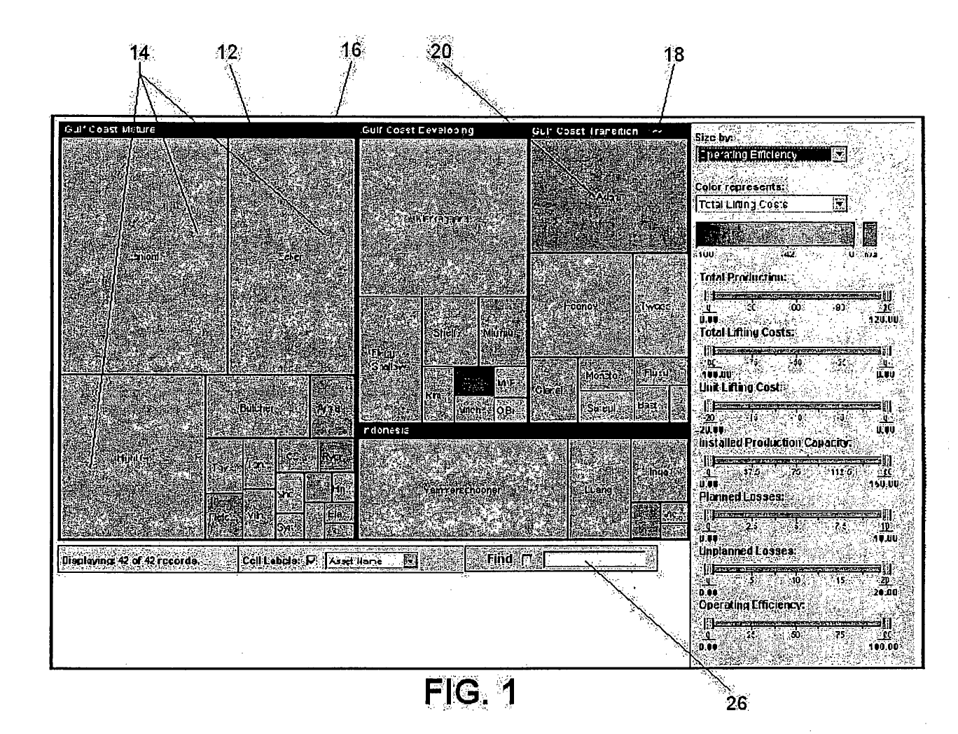

The preferred method of providing a concurrent overview and detailed display of industrial production facilities will now be described with reference to FIG. 1 through 6.

Referring to FIG. 1, display 12 consists of rectangle tiles with near-square spaces or elements 14 of varying area and appearance. Elements 14 fill the entire available area of display 12 with no gaps. The parent rectangle or container area 16 has an aspect ratio similar to the aspect ratio of the display device, making maximum use of the resolution of the display device when the parent container is set to maximum size. In practice, not all of elements 14 are exactly square. When container area 16 is completely filled with elements 14, some of elements 14 must deviate from square. This compromise is made preferentially with the smallest of elements 14. Because, in the preferred assignment of element size, the largest of elements 14 are the most important for size comparison, it is important that they are the most truly square, since squares are easier to visually distinguish by area than are rectangles of non-square and varying aspect ratio.

Element Size

The area of each element 14 is controlled by some measured or calculated attribute of the item represented by element 14. The range of possible element areas is constrained at the largest area by the size of display area 12 and at the smallest area by the dot pitch of the display device and the resolving power of the eye, and overall by the total number of elements 14 that must be displayed. Within these constraints, the element area corresponds to the possible numerical range of the attribute controlling the element size. Alternatively, the range of possible element sizes can correspond to the actual numerical range of the attribute controlling the element area within the set of data currently being represented.

Element Color

The color of each element 14 is determined by some measured or calculated attribute of the item represented by the element. The possible colors can correspond to a continuous range of attribute values, they can indicate discrete attribute “buckets”, the sign of a change in attribute value, alarm conditions or go or no-go conditions, any combination of these, or other schemes for mapping to value. The range of possible element colors corresponds to the possible numerical range of the attribute controlling the element color. Alternatively, the range of possible element colors can correspond to the actual numerical range of the attribute controlling the element color within the set of data currently being represented. Also, a range of gray intensity values or single-hue intensity values can be used as the color range. The hue can indicate one attribute (red for declining performance and green for improving performance, for instance) and the intensity can indicate a further attribute (bright red for a large decline, light pink for a slight decline).

Sorting by Relative Size

For each set of elements 14, sorting can be applied that places elements 14 so that there is a general progression from largest element in the top-left corner of parent container 16 to the smallest in the bottom-right corner.

Additional Presentation Features

Grouping

Display 12 can represent a hierarchical structure by showing elements 14 within element containers 18 that are themselves nested within other, parent containers 16. The overall area of each container 16 below the top level can be controlled by some aggregate measure of the area-controlling attribute of all of the contained elements, relative to the same measure for sibling containers.

Element containers 18 can also be used to indicate simple categorical groupings of assets. For example, a set of industrial assets can be grouped by geographical situation (container name=“Northwest Gas Plant”, for instance) or by asset function (container name=“Boost Pumps”, for instance). Element containers 18 can also be used to group assets according to some portion of a continuous range of data (container name=“Flow Rate Below 50% of Design”, for instance).

Labels and Markers

Each element can have a text label 20 assigned to it. The label can report the name or other identifier for the element. Instead of this or in addition, the label can be the description of the element. Instead of these or in addition, the label can report the value of any attribute of its associated asset. This can be the value of an attribute that is currently controlling some aspect of the element's appearance or some other attribute.

Each element can have a symbolic graphical item assigned to it. These can be icon-type images or glyphs. The graphical item can indicate some state of the element (“disabled”, for instance) or be used as a mnemonic marker (“bookmark”).

Besides area, color, group membership, and label, the element appearance and behavior can be modified according to the following supplemental means of distinction:

Texture

Each element 14 can have a transparent overlay that presents variations in both pattern and texture. Pattern is the visual arrangement of the elements (crosshatch or dots, for example) and texture is the scale of the pattern (coarse-fine or large-small, for example). By using an appropriate pointing device like a haptic mouse, the user can sense the pattern and texture by touch.

Graphs, Plots, and Images

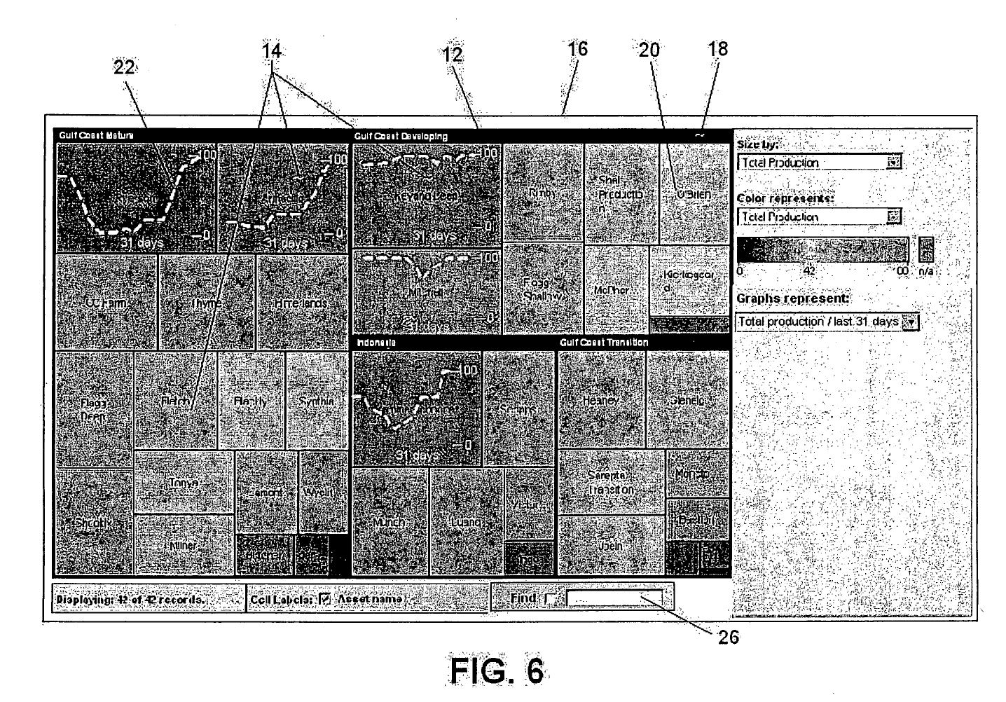

Referring to FIG. 6, graphs 22 can be provided for parent container 16, element containers 18 and elements 14. The graphical item on an element 14 can also be a transparent thumbnail version of a graph over time, for example, of one or several attributes of the asset represented by the element. Other plots can be displayed; for example, pie graphs or star plots. The graphical item can be a photographic image that is small enough relative to the element to allow viewing of the element color around the border of the photograph.

Motion

The graphical item can exhibit motion to indicate some special condition or state of the asset represented by the element. The motion can be animation along a path or flipping, flopping, rotation, pulsation or reciprocation in place. The element itself can exhibit any of these motions. Relative speed of motion can indicate relative values of element attributes.

Sounds

The system can produce sounds to accompany changes in the values of element attributes. The sounds can vary in character according to the type and magnitude of the change.

User Interaction

The user interacts with the Presentation Component by filtering, zooming, searching, viewing supplemental information, or changing the attributes that control the appearance in terms of both element color and area (or any of the supplemental means).

Filtering

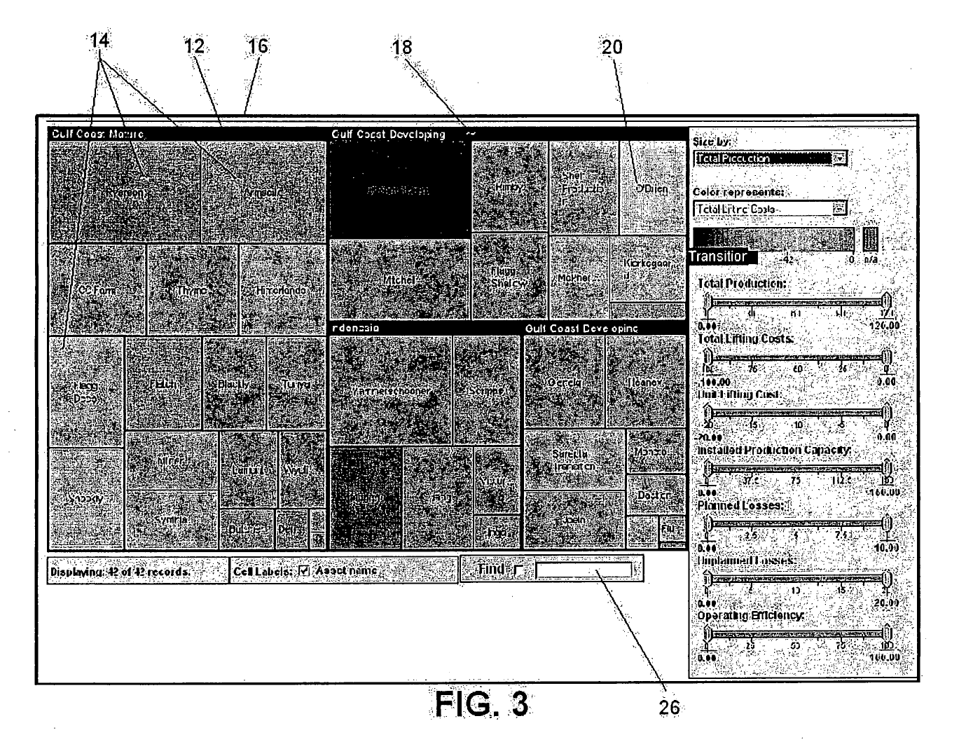

The membership of the set of elements 14 visible at any one time can be altered through filtering. Elements can be hidden based upon any categorical attribute or range of values for a continuous attribute of the element. Filtering can be accomplished by selecting filter terms from a list (categorical or continuous) or by directly manipulating a slider control (continuous values) as shown in FIGS. 1 and 3 down the right hand side.

Supplemental Information Pane

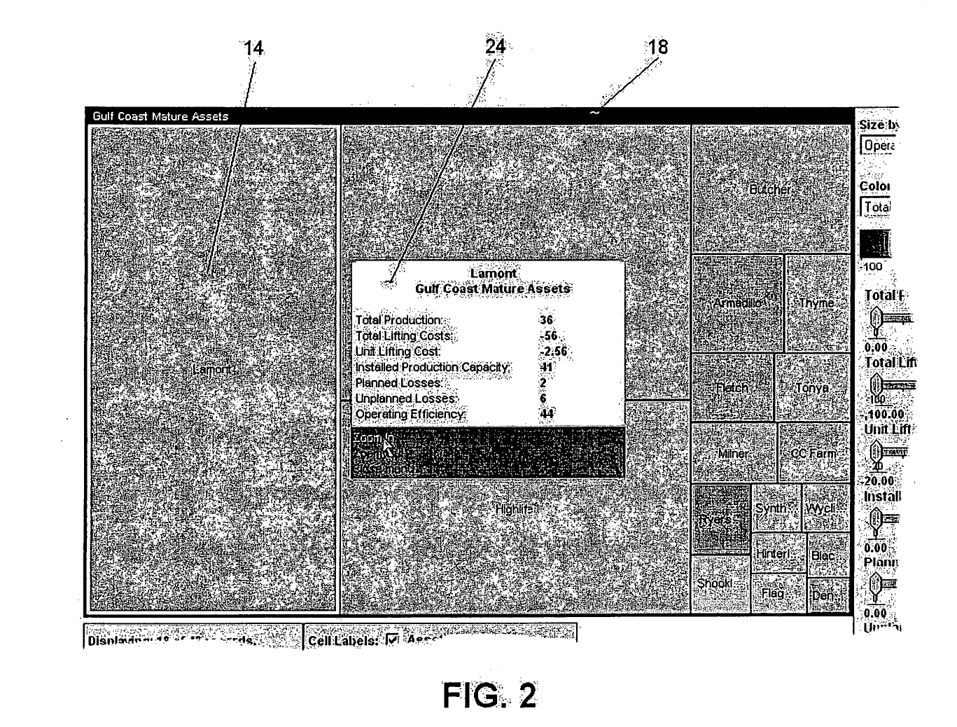

Referring to FIG. 2, when the user hovers the pointing device cursor over an element, the presentation component will display supplemental information within a pop-up pane 24 adjacent to element 14. Supplemental information can include a list of the values of all known attributes of the element and information about the quality of the data; for example, compression factor, sample rate, or percent good lab tests. Images can be presented in the pop-up pane.

By clicking (or otherwise indicating the command) on an element whose supplemental information is visible, the presentation component presents a list of all element attributes. By clicking (or otherwise indicating the command) on any of the attributes in the list the presentation component will make a historical record of the value of that attribute available for use in software outside of the display, where the value may be shown as a trend or manipulated in diverse ways.

Zooming

Referring to FIG. 2, by clicking (or otherwise indicating a command) on an element whose supplemental information is visible, if the display contains multiple element groups, the command “zoom” becomes available. By clicking (or otherwise indicating the command) on the zoom command, the element container 18 of which element 14 is a member will expand to fill the display area at the expense of the other groups. The reverse zoom out function is provided by similar means.

Searching

Referring to FIG. 3, by typing text in a search box 26, the user can cause the presentation component to dynamically limit the set of displayed elements to those whose name or other descriptor matches the typed text.

The user can change which attributes control the element area, color or supplementary means of element distinction. Also, the user can specify the contents of the element labels. Users with visual color deficiencies can switch the color scales for ones more readily distinguishable with their deficit.

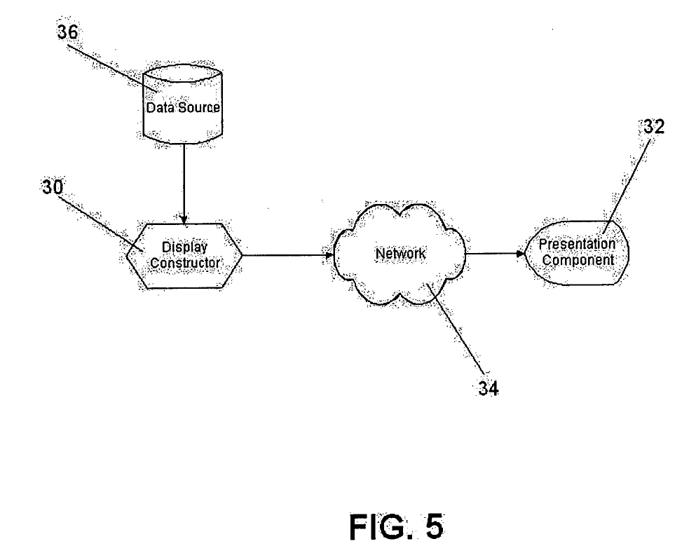

Referring to FIG. 5, there is illustrated a Major Component Block diagram setting forth the system components.

Display Constructor

The Display Constructor 30 sets the basic features of the display as viewed in Presentation Component 32. The Constructor 30 serves up the display through network 34 to Presentation Component 32. The data source connections are set up between data source 36 and Constructor 30.

Presentation Component

Presentation Component 32 is where the display is viewed and controlled by the user. It resides on the end-user's computer workstation.

Computer Workstation

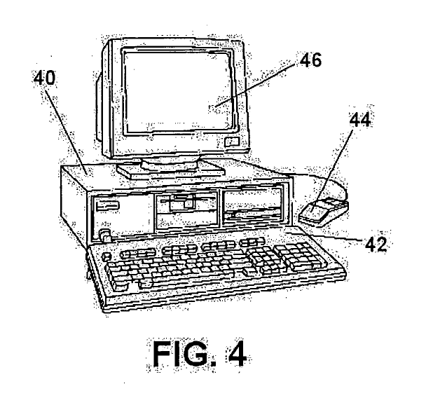

Referring to FIG. 4, there is nothing remarkable about the computer workstation. The system presents the display 12 to the user on a computer 40 having a keyboard 42, pointing device (usually a mouse 44) and video display unit 46.

Use in accordance with the teachings of the method will now be described with reference to an example. Referring to FIG. 1, elements 14 on display 12 represent petroleum wells. The wells represented by elements 14 are grouped in element containers 18 by location and asset maturity (Gulf Coast—Developing, Transition, and Mature) and by location (Indonesia). The element color represents Total Lifting Costs. The color scale runs from deep red at a cost of −100, through orange in the −70 to −50 area, through a narrow yellow warning zone at −42, ending in deep green at a cost of zero. Element area represents overall Operating Efficiency of a well, in percent. The larger the element, the lower the Operating Efficiency of the well it represents. The element label reports 20 the name of the well.

Scenario One

The user would like to find the well or wells that meet the following combined criteria: those with both the largest lifting costs and the worst operating efficiency. With the Presentation Component configuration described above, the bigger the element, the worse its operating efficiency and the closer its color to the red end of the color scale, the higher its lifting costs. Therefore, discerning which well most closely meets the user's criteria is a simple matter of finding the largest, reddest, square.

The well named “Lamont” is quite large and is strongly orange. Referring to FIG. 2, by clicking on element 14 bearing the label “Lamont”, element container 18 containing “Lamont” expands to fill the screen. By hovering the cursor over Lamont, supplementary information pane 24 will appear. From this pane 24, the user can see that, indeed, Lamont has high lifting costs (−56) and low operating efficiency (44).

Scenario Two

If the user now needs to determine where best to expend effort in reducing lifting costs, finding the wells that have both large total production and high lifting costs would be useful. By setting size=Total Production and color=Total Lifting Costs, the display of FIG. 3 results. In this case, the user is again interested in wells that are the largest and reddest.

The wells “Keyano Deep”, “Ryerson”, “Armadillo”, “Munch”, and “Fletch” are both large and colored red to orange. The supplementary information pane for each confirms that these wells meet the selection criteria.

### SUMMARY

In each of these cases, the user is able to simply and quickly discover which wells in a set of 42 meets the selection criteria. This is done without reading, recalling, and comparing numerical or textual information. The comparisons are all made visually. In practice users seem to have no special difficulty with sets of up to 1500 members.

Comparative Advantages:

With an “electronic spreadsheet” the user must mentally recall information from one cell of the table for comparison with information in other cells of the table. When using a tabular view, it is difficult to see patterns in the information unless the set of information is trivially small. The process tends to be error prone and time consuming. Even when correct conclusions are drawn from the information, it is often too late to act effectively. With the “digital dashboard”, the user does not see all the original data. This can obscure characteristics of the data set; it is impossible to identify outlier data set members, for instance. Mistaken conclusions can cause wasted tine and misused resources in the management of assets. In contrast, the present invention enforces comparisons by placing visual elements representing industrial assets adjacent to one another in space. Since the appearance of these elements is controlled by some attribute of the asset that they represent, a direct visual comparison is sufficient to immediately understand the relative differences amongst large number of industrial assets, all at once. Compared to using an “electronic spreadsheet” display, the display technique of the present invention is faster, more certain and less error prone. Compared to a “digital dashboard” display, the display technique of the present invention is comprehensive, that is, the viewer can see all of the data at once in its original, unaltered form.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

1. A method of providing a concurrent overview and detailed display of an industrial production facility, comprising the step of:
monitoring selected assets of an industrial production facility by assigning to each of the selected assets a space on a visual display, a selected attribute common to some or all of the selected assets being reflected in a size of the space assigned to an individual one of the selected assets, such that selected assets having more of the selected attribute are assigned a proportionately larger space than selected assets having less of the selected attribute.

2. The method as defined in claim 1, including a step of indicating another selected attribute common to some or all of the selected assets in a colouration of the space assigned to the individual one of the selected assets, a range of colouration being provided with each colour being indicative of a quantity of the selected attribute possessed by the individual one of the selected assets.

3. The method as defined in claim 1, including a step of grouping the spaces together on the visual display by size, such that there is a general progression from largest to smallest.

4. The method as defined in claim 1, including a step of providing a hierarchical structure of spaces in which some of the spaces on the visual display are positioned within element containers.

5. The method as defined in claim 1, including a step of providing a label for each space that is one of a descriptor of the selected asset, a numerical value of the selected attribute of the selected asset, or an indicator of the state of the selected asset.

6. The method as defined in claim 1, including a step of indicating another selected attribute common to all of the selected assets by a pattern of the space assigned to the individual one of the selected assets, a range of patterns being provided with each pattern being indicative of a quantity of the selected attribute possessed by the individual one of the selected assets.

7. The method as defined in claim 1, including a step of indicating another selected attribute common to all of the selected assets by a texture of the space assigned to the individual one of the selected assets, a range of textures being provided with each texture being indicative of a quantity of the selected attribute possessed by the individual one of the selected assets.

8. The method as defined in claim 1, including a step of indicating another selected attribute common to all of the selected assets by a graphic representation positioned within the space assigned to the individual one of the selected assets, the graph being indicative of a quantity of the selected attribute possessed by the individual one of the selected assets.

9. The method as defined in claim 8, including a step of placing the graphic representation in notion when some defined condition exists.

10. The method as defined in claim 9, including a step of having a speed of the motion indicative of a quantity of the selected attribute possessed by the individual one of the selected assets.

11. The method as defined in claim 1, including a step of having an audio tone accompany changes in the selected attribute.

12. The method as defined in claim 11, including a step of having a quality and magnitude of the tone indicative of a quantity of the change in the selected attribute.

13. The method as defined in claim 1, including a step of providing a filtering command to limit those selected assets displayed on the visual display to only those assets for which the selected attribute is within a selected range of values.

14. The method as defined in claim 4, including a step of providing a zooming command which causes one of the element containers to expand to fill the visual display.

15. The method as defined in claim 1, including a step of providing a searching command with a search term entry box, which causes the visual display to display only those of the selected assets matching the search term entered into the search term entry box.

16. The method as defined in claim 1, including a step of providing a supplemental information pane for each of the selected assets, the supplemental information pane being selectively activated.

17. The method as defined in claim 1, including a step of providing an attribute selection command with an attribute entry box, which causes the relative size of the spaces to be reconfigured in accordance with the attribute entered into the attribute entry box.
